(19) United States
(12) Patent Application Publication
(10) Pub. No.: US 2013/0019179 A1
(43) Pub. Date: Jan. 17, 2013

(54) MOBILE APPLICATION ENHANCEMENTS

(71) Applicant: Karl Ke Zhao, Irvine, CA (US)

(72) Inventor: Karl Ke Zhao, Irvine, CA (US)

(73) Assignee: DIGILINK SOFTWARE, INC., Irvine, CA (US)

(21) Appl. No.: 13/543,664

(22) Filed: Jul. 6, 2012

Related U.S. Application Data
(60) Provisional application No. 61/507,976, filed on Jul. 14, 2011.

(51) Int. Cl. G06F 3/01

(52) U.S. Cl. 715/733

(57) ABSTRACT

A system and a method for displaying presentation data based on user interactions are provided. The user interactions are received by a mobile device that transmits the user interactions to a virtual mobile adaptor executing an application. The user interactions are then associated with the application and a presentation content is generated based on integrating the user interaction data with the application. The presentation content is then transmitted to a virtual mobile display. The user interactions may be communicated from the mobile device to the virtual mobile adaptor via a cloud-based network.

### CROSS-REFERENCE TO RELATED APPLICATIONS

This application claims the benefit of U.S. Provisional Patent Application No. 61/507,976, filed Jul. 14, 2011, the disclosure of which is hereby incorporated by reference in its entirety.

### FIELD OF THE INVENTION

The present invention relates generally to mobile device games and applications and more particularly to a method and a system for virtualizing a console game system with mobile devices.

### BACKGROUND

With the increase in popularity of handheld devices, the users have begun to use their mobile devices to interact with a variety of applications such as video games. The ability to play video games on mobile devices has allowed users to play these games in a number of different locations. As tablets become more and more popular, it is not uncommon to find two people who get together with a tablet and two smart phones. However, the users usually spend a significant amount of time at home while playing games on mobile devices. It will be beneficial for the users to interact with mobile devices while viewing images related to the applications on a big screen device, such as a television to increase enjoyment of interacting with the applications.

In light of foregoing discussion, a simple method and a system is required that allows users to interact with a mobile device-based application while viewing images related to the application on a secondary display device, such as a television screen, a tablet, a Smartphone with a large display etc.

### BRIEF SUMMARY OF THE INVENTION

Accordingly in an aspect of the present invention a system for using user interaction data and displaying content generated with said user interaction data on another device with or connected to a secondary display is provided. The system comprises of: a mobile device to receive user interaction; a virtual mobile adaptor communicatively coupled to the mobile device through a network link; an application programming interface to generate a presentation content based on the user interactions; and a virtual mobile display connected to the virtual mobile adaptor, the said virtual mobile display capable of displaying the presentation content on the screen.

In another aspect of the present invention, a method for using user interaction data and displaying content generated with said user interaction data on another device with or connected to a secondary display is provided. The method comprises of: inputting user interaction data through a mobile device; transferring the user interaction data to a virtual mobile adaptor through a network link; associating the user interaction data with an application programming interface; generating a presentation content based on the said association; and transmitting the presentation content to a virtual mobile display.

In yet another aspect of the present invention, a method for generating feedback on user interactions is provided. The method comprises of: receiving the user interactions through a mobile device; transmitting the user interactions to a virtual mobile adaptor with an application programming interface; integrating the user interaction data with the application programming interface; generating the feedback data based on the integration of said interaction data with the application programming interface; and transmitting the feedback data in form of stimulus to the mobile device in response to the user interaction data received by the mobile device.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 is a schematic diagram of an exemplary architecture of a system for use in accordance with an embodiment of the present invention.

FIG. 2 is a schematic diagram illustrating a plurality of mobile devices connected to a virtual mobile adaptor in accordance with an embodiment of the present invention.

FIG. 3 is an illustration showing the interaction of mobile device to a virtual mobile adaptor in accordance with an embodiment of the present invention.

FIG. 4 is a system architecture illustrating the transfer of presentation data to a secondary display device through a cloud-based network in accordance with an embodiment of the present invention.

FIG. 5 is a flow diagram illustrating the method used to transfer the presentation data on a mobile device to a secondary display device in accordance with an embodiment of the present invention.

FIG. 6 is a block diagram showing the computing system that may be used in accordance with an embodiment of the present invention.

### DETAILED DESCRIPTION OF EMBODIMENTS

In the following detailed description of embodiments of the invention, numerous specific details are set forth in order to provide a thorough understanding of the embodiment of invention. However, it will be obvious to a person skilled in art that the embodiments of invention may be practiced without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variation, substitutions and equivalents will be apparent to those skilled in the art without parting from the spirit and scope of the invention.

The present invention provides a system and a method thereof that allows users to interact with a mobile device based application while viewing images related to the application on a secondary electronic device, such as a television screen. The user utilizes the mobile device as an input device and can view the displaying image from the application on a large display area of an auxiliary electronic device. The mobile device based application receives the user interaction data to generate a presentation content based on the association of user interaction data with the application. The presentation content is then transmitted to a virtual mobile display through a virtual mobile adaptor.

In an embodiment of the present invention the mobile device based application may be executed on the virtual mobile adaptor. The virtual mobile adaptor may comprise a tablet, a Smartphone, a smart TV, a cable box, a set-top box, a standalone box, cable/satellite/IP set top boxes or other electronic device comprising a board to run the mobile-device based application.

The user interaction with the mobile device is transmitted from the mobile device to the virtual mobile adaptor in form of the user interaction data via a network link such as a Wi-Fi, a Bluetooth, USB and many more. The virtual mobile adaptor processes the user interaction data and generates a presentation content associated with the application. The presentation content is then transmitted to a virtual mobile display such as a TV, a LCD, a projector or a goggle.

In an embodiment the display may be built into the virtual mobile adaptor for instance smartphone with large display, tablet, or smart TV.

The user interactions with the mobile device may comprise use of a touchpad, slide, point and click device emulation, accelerometer, orientation, motion sensor, navigator, gyroscope or other sensor based control, microphone, camera (both regular and stereoscopic mode), camera based gesture or a combination thereof.

In another embodiment of the present invention the virtual mobile adaptor running the mobile device-based application may also generate feedback data based on the user interaction data. For instance, if the user interaction data indicates that a user engaged in a mobile device-based video game is steering a car on a gravel road, the virtual mobile adaptor may generate feedback data that initiates vibrations in the user's mobile device. Feedback may also comprise sounds, beeps or smell. Accordingly, embodiments of the present invention allow for two-way communication between an input device, such as a mobile device, and a virtual mobile adaptor.

In another embodiment of the present invention multiple user devices may interact with the virtual mobile adaptor. This implies that multiple number of players may interact with an application, such as a video game, that runs on the virtual mobile adaptor. For example, the mobile device-based video game application may run on the virtual mobile adaptor with the multiple user devices providing input to the virtual mobile adaptor. The virtual mobile adaptor may analyze the input from each of the virtual mobile devices and generate responsive feedback to each of the virtual mobile devices accordingly.

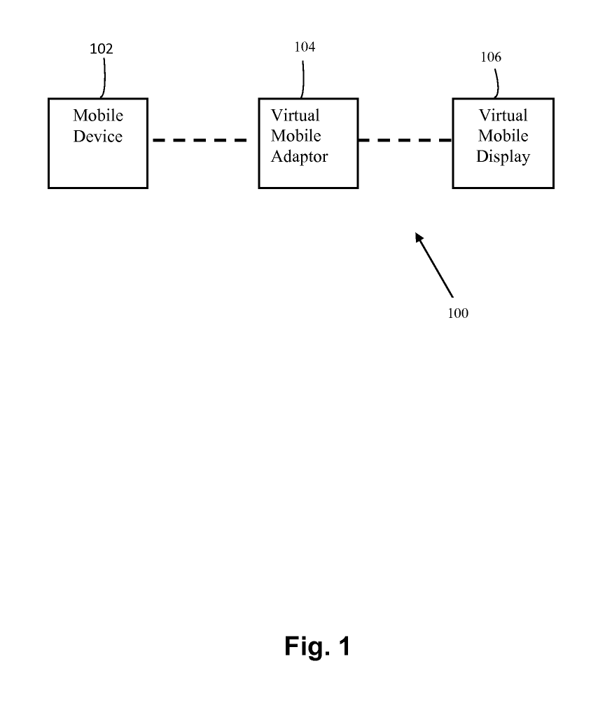

FIG. 1 is a schematic diagram of an exemplary architecture of a system for use in accordance with an embodiment of the present invention. Referring to FIG. 1, an architecture 100 for transmitting data to a secondary display device is provided. The architecture 100 comprises of a mobile device 102, a virtual mobile adaptor 104 and a virtual mobile display 106. The mobile device 102 is communicatively coupled to the virtual mobile adaptor 104 via a network link. In particular the network link such as a Wi-Fi network, a Bluetooth, USB, IR, NFC internet and a cloud-based network may be used for coupling the mobile device 102 communicatively with the virtual mobile adaptor 104.

The virtual mobile adaptor 104 is communicatively coupled to the virtual mobile display 106 via an HDMI line, an MHL line, a component video, a composite video and audio, a digital audio, a USB or other links for raw or compressed graphics, video, audio, or combinations thereof.

In another embodiment of the present invention the mobile device 102 and/or the virtual mobile adaptor 104 may include any general purpose computing system that may implement a web browser application or other suitable applications adapted to request and provide information (such as web content) to and from a server.

The mobile device 102 may be any computing device that is capable of running an application. The mobile device 102 may also have web accessibility, and may comprise a personal digital assistant, a video player, a handheld communications device, a workstation, any combination of these delineated devices, or any other device that may use a wireless communication network to communicate. The mobile device 102 may include, for example, a display(s), a power source(s), a data store(s), a speaker(s), memory, a buffer(s), and the like.

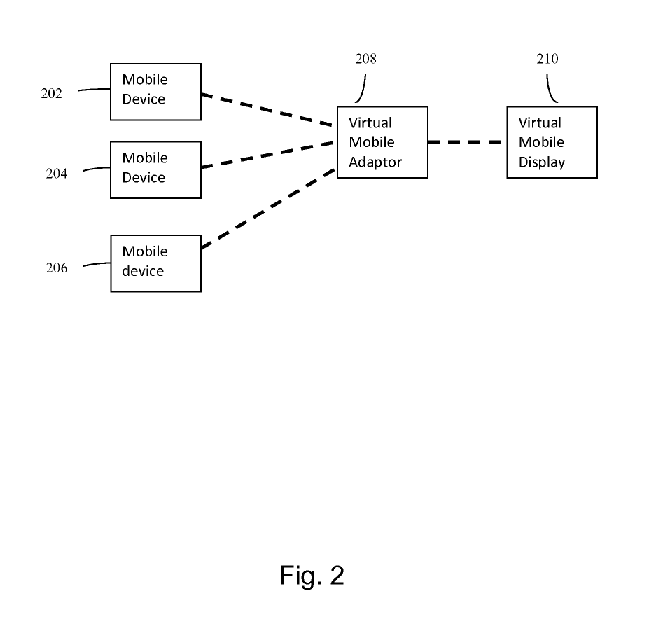

FIG. 2 is a schematic diagram illustrating a plurality of mobile devices connected to a virtual mobile adaptor in accordance with an embodiment of the present invention. Referring to FIG. 2, a plurality of mobile device 202, 204 and 206 communicatively connected to a mobile adaptor 208 is shown. The mobile devices 202, 204 and 206 are communicatively coupled to the virtual mobile adaptor 208 via one of a number of network link, such as a Wi-Fi™ network, Bluetooth™, USB, IR, NFC, or other network link. User interactions with the mobile devices 202, 204 and 206 are communicated to the virtual mobile adaptor 208. At the virtual mobile adaptor 208, the user interactions may be analyzed and associated into an application executing on the virtual mobile adaptor 208. The application is not dependent on the modification of low level components in a mobile operating system. As such, embodiments of the present invention may be used to create a new type of mobile game and application usage. Alternatively, the application may be executed with modification of low level components in a mobile operating system, such as Android, as well as other popular mobile operating systems along with one or more high level application suites for ease of use by the consumer. As such embodiments of the present invention may be used to interact with an existing and popular mobile game and application usage. Further, with a mobile device as an input and output device, multiple touch gestures may be used as user interactions, allowing a great diversity of applications that include but are not limited to social networking, voice, video chatting, or a combination thereof in a family or group setting to be created or to be reused with embodiments of the present invention. Based on the user interactions, virtual mobile adaptor 208 may generate presentation data associated with the application. The presentation data may be displayed on a virtual mobile display 210.

In an embodiment of the present invention the virtual mobile adaptor 208 may generate a feedback data to send to one or more of the mobile devices 202, 204 and 206. In particular, the virtual mobile adaptor 208 may generate feedback data to initiate vibrations in one or more of the mobile devices 202, 204 and 206 based on the user interactions received at virtual mobile adaptor 208. The feedback data generated may be based on the application running on virtual mobile adaptor 208. For instance, if an application running on virtual mobile adaptor 208 is directed towards a video game, vibration, sound, or smell feedback data may be appropriate. Alternatively, if an application running on virtual mobile adaptor 208 is directed towards a quiz show, sounds, pictures, videos related to the quiz show, or videos private to the user of a specific mobile device in a multiplayer mode may be appropriate forms of feedback data.

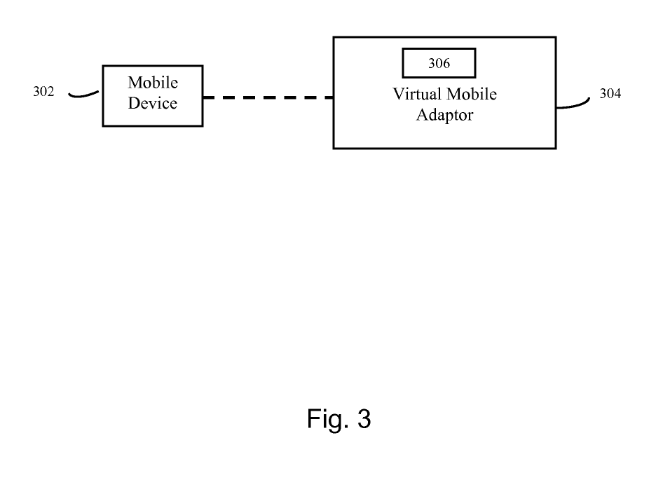

FIG. 3 is an illustration showing the interaction of mobile device to a virtual mobile adaptor in accordance with an embodiment of the present invention. Referring to FIG. 3, the virtual mobile adaptor 304 comprises a display 306 within the structure of the virtual mobile adaptor 304. Accordingly, the mobile device 302 may be communicatively coupled to the virtual mobile adaptor 304 via a Wi-Fi™ network, Bluetooth™, USB, IR, NFC, or other network link. Once user interaction data is received at the virtual mobile adaptor 304, presentation data generated based on the user interaction data may be directly presented on the display 306 of virtual mobile adaptor 304.

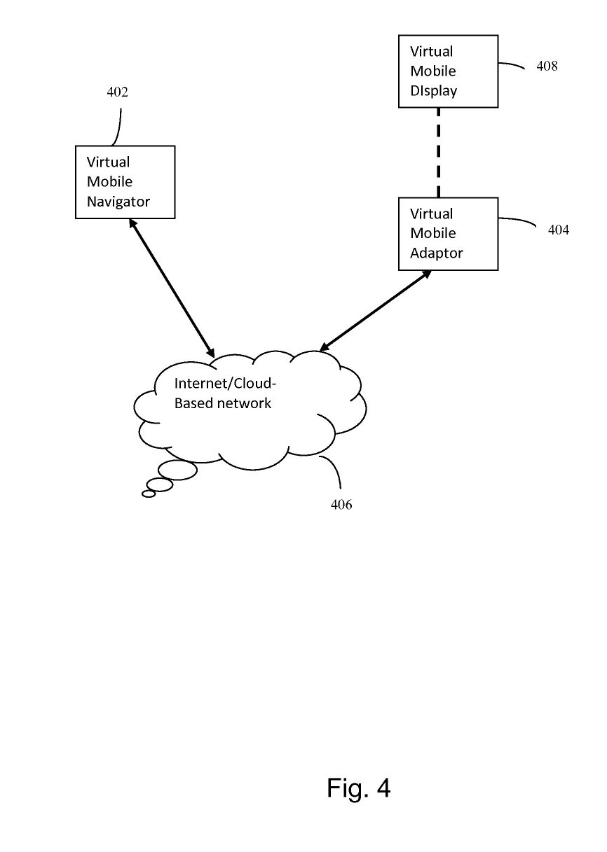

FIG. 4 is a system architecture illustrating the transfer of user interaction data to a device connected to or with a secondary display device through a cloud-based network in accordance with an embodiment of the present invention. Referring to FIG. 4 a virtual mobile navigator 402 is communicatively connected to a virtual mobile adaptor 404 in an internet/cloud-based network 406 through a communication mean. The term “communication mean” includes RSS and news feeds, web content aggregators, web engines, one or more web page, social networking medias, search engines, online and engines, banner engines, online news group, forums, web applications (both standard and mobile), any combinations thereof, or the like. The user interacts with virtual mobile navigator 402 and the user interaction data is transmitted to virtual mobile adaptor 404 via a cloud network. The virtual mobile adaptor 404 in turn generates feedback data that is transmitted to the virtual mobile navigator 402. Thus, a two way user interaction data exchange is carried out in the cloud network 406. The received user interaction data received in the cloud 406 is analyzed and statistics of the user data is stored in the cloud network 406 for future reference. A user experience preference profile is created in the cloud network 406 that connotes to the preference of the user. The personal preference profile is then send to the virtual mobile adaptor 404. The cloud based network 406 enables continued improvement of user experience through analyzing user interaction data as well as adding multiple value added services for the platform. The virtual mobile adaptor 404 then transmits the data on a secondary display device 408.

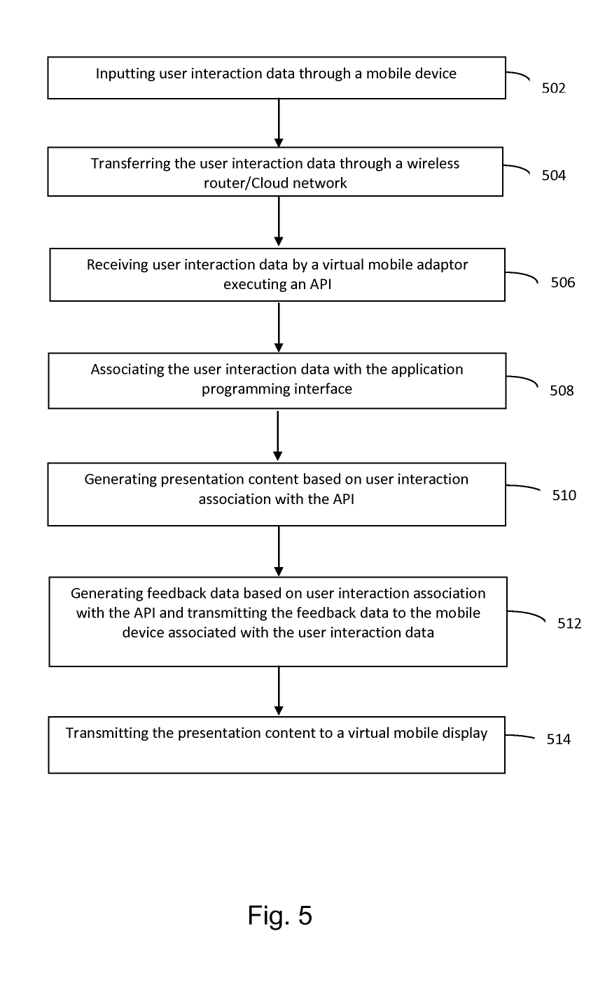

FIG. 5 is a flow diagram illustrating the method used to transfer the presentation data on a mobile device to a secondary display device in accordance with an embodiment of the present invention. The method comprises of: Step 502: the user interaction data is inputted through a mobile device, the mobile device is any general computing device that may include but is not limited to a smartphone, tablet or a controller unit. The user interaction data is then transferred through a cloud network or wireless router to the virtual mobile adaptor as shown in block 504. The virtual mobile adaptor includes but is not limited to a tablet, a Smartphone, a smart TV, a set-top box, a cablebox or a standalone box. The virtual mobile adaptor is executed with an application programming interface that has the ability to generate presentation content based on user interaction as shown in block 506. The virtual mobile adaptor associates the user interaction with the application programming interface to analyze the user interaction inputs as shown in block 508. The user interaction data may comprise gestures, orientation, touchpad, point and click device emulation and many more. The application programming interface generates the presentation data based on the inputs of user interaction as shown in block 510. The application programming interface can also in turn generate feedback data that may be transmitted to the virtual mobile device, thus allowing two way user interaction exchanges as shown in block 512. The generated presentation content is then transmitted to the secondary display device as shown in block 514.

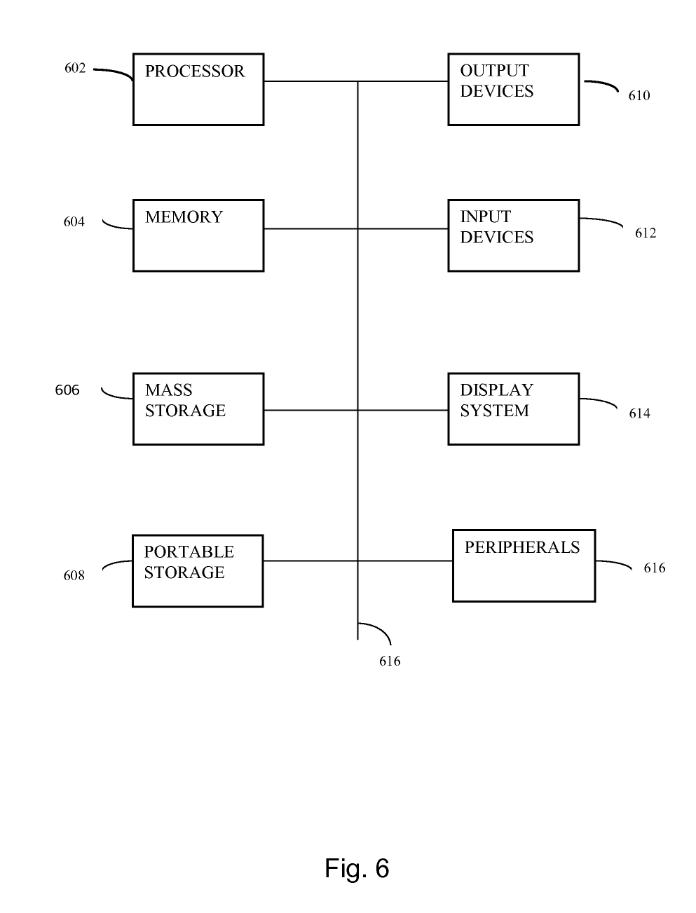

FIG. 6 is a block diagram showing the computing system that may be used in accordance with an embodiment of the present invention. Referring to FIG. 6 an exemplary computing system 600 that may be used to implement an embodiment of the present technology is illustrated. The computing system 600 includes one or more processors 602 and a memory 604. The memory 604 stores, in part, instructions and data for execution by the processor 602. The memory 604 can store the executable code when the system 600 is in operation. The system 600 may further include a mass storage device 606, a portable storage medium drive(s) 608, an output devices 610, a user input device 612, a graphics display 614, and other peripheral devices 616.

The components are depicted as being connected via a single bus 618. The components may be connected through one or more data transport means. The processor unit 602 and main memory 604 may be connected via a local microprocessor bus, and the mass storage device 606, the peripheral device(s) 616, portable storage device 608, and the display system 614 may be connected via one or more input/output (I/O) buses.

The mass storage device 606, which may be implemented with a magnetic disk drive or an optical disk drive, is a non-volatile storage device for storing data and instructions for use by the processor unit 602. The mass storage device 606 can store the system software for implementing embodiments of the present technology for purposes of loading that software into the main memory 604.

The portable storage device 608 operates in conjunction with a portable non-volatile storage medium, such as a floppy disk, a compact disk or a digital video disc, to input and output data and code to and from the computing system 600. The system software for implementing embodiments of the present technology may be stored on the portable medium and input to the computing system 600 via the portable storage device 608.

The input devices 612 provide a portion of a user interface. Input devices 612 may include an alphanumeric keypad, such as a keyboard, for inputting alphanumeric and other information, or a pointing device, such as a mouse, a trackball, stylus, or cursor direction keys. Additionally, the system 600 includes output devices 610. Suitable output devices include speakers, printers, network inter faces, and monitors.

The display system 614 may include a liquid crystal display (LCD) or other suitable display device. The display system 614 receives textual and graphical information, and processes the information for output to the display device. The peripherals 616 may include any type of computer support device to add additional functionality to the computing system. The peripheral device(s) 616 may include a modem or a router.

The components contained in the computing system 600 are those typically found in computing systems that may be suitable for use with embodiments of the present technology and are intended to represent a broad category of such computer components that are well known in the art. Thus, the computing system 600 can be a personal computer, hand held computing system, telephone, mobile computing system, workstation, server, minicomputer, mainframe computer, or any other computing system. The computer can also include different bus configurations, networked platforms, multi-processor platforms, and many more. Various operating systems can be used including UNIX, Linux, Windows, Macintosh OS, Palm OS, and other suitable operating systems.

Some of the above described functions may be composed of instructions that are stored on storage media (e.g., computer readable medium). The instructions may be retrieved and executed by the processor. Some examples of storage media are memory devices, tapes, disks, and the like. The instructions are operational when executed by the processor to direct the processor to operate in harmony with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a central processing unit (CPU) for execution. Such media can take many forms that include but are not limited to, non-volatile media, volatile media and transmission media. Non-volatile media include, for example, optical or magnetic disks, such as a fixed disk. Volatile media include dynamic memory, such as a system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

What is claimed is:

1. A system for using user interaction data and displaying content generated with said user interaction data on another device comprising:
a mobile device to receive user interaction;
a virtual mobile adaptor communicatively coupled to the mobile device through a network link;
an application programming interface to generate a presentation content based on the user interactions; and
a virtual mobile display connected to the virtual mobile adaptor, the said virtual mobile display capable of displaying the presentation content on the screen.

2. The system of claim 1 wherein the network link between the virtual mobile adaptor and the mobile device is selected from the group consisting of a Wi-Fi network, a Bluetooth, a USB, an IR, a NFC internet, and a cloud based network.

3. The system of claim 2 wherein the communication in cloud based network is performed through a RSS, a news feed, a web content aggregator, a web engine, a social networking media, a search engine, an online advertisement engine, a banner engine, an online news group, a forum, a standard web application or a mobile web application.

4. The system of claim 1 wherein the user interaction with the mobile device comprises a component selected form the group consisting of a touchpad, a slide, a point and click device emulation, an accelerometer, an orientation, a motion sensor, a navigator, a gyroscope, a sensor based control, a microphone, a camera, a camera based gesture or a combination thereof.

5. The system of claim 1 wherein the virtual mobile device is integrated into the virtual mobile adaptor.

6. The system of claim 1 wherein the application programming interface is executed on the mobile device or the virtual mobile adaptor or at the both end.

7. The system of claim 1 wherein the virtual mobile display is connected to the virtual mobile adaptor through a component selected from the group consisting of a HDMI line, a MHL line, a component video, a composite video and audio, a digital audio, USB, links for graphics, video, audio or combination thereof.

8. The system of claim 1 wherein the mobile device and the virtual mobile adaptor are having two-way communication between them.

9. The system of claim 1 wherein the virtual mobile adaptor is connected to a plurality of the mobile devices.

10. A method for using user interaction data and displaying content generated with said user data on another device comprising:
inputting user interaction data through a mobile device;
transferring the user interaction data to a virtual mobile adaptor through a network link;
associating the user interaction data with an application programming interface;
generating a presentation content based on the said association; and
transmitting the presentation content to a virtual mobile display.

11. The method of claim 10 wherein the user interaction data comprises of a component selected from the group consisting of a touchpad, a slide, a point and click device emulation, an accelerometer, a orientation, a motion sensor, a navigator, a gyroscope, a sensor based control, a microphone, a camera, a camera based gesture or a combination thereof.

12. The method of claim 10 wherein the application programming interface generates the presentation content in response to the user interactions.

13. The method of claim 10 wherein the network link comprises of a component selected from the group consisting of a Wi-Fi network, a Bluetooth, a USB, an IR, a NFC internet and a cloud based network.

14. The method of claim 10 wherein the presentation content is transmitted through a component selected from the group consisting of a HDMI line, an MHL line, a component video, a composite video and audio, a digital audio, USB, links for graphics, video, audio or combination thereof.

15. A method for generating feedback data based on user interactions comprising:
receiving the user interactions through a mobile device;
transmitting the user interactions to a virtual mobile adaptor with an application programming interface;
integrating the user interaction data with the application programming interface;
generating the feedback data based on the integration of the said interaction data with the application programming interface;
transmitting the feedback data in form of a stimulus to the mobile device in response to the user interaction received by the mobile device.

16. The method of claim 15 wherein the user interactions comprises a component selected form the group consisting of touchpad, a slide, a point and click device emulation, an accelerometer, a orientation, a motion sensor, a navigator, a gyroscope, a sensor based control, a microphone, a camera, a camera based gesture or a combination thereof.

17. The method of claim 15 wherein the feedback comprises of a vibration, a sound, a beep signal or a smell.

18. The method of claim 15 wherein the type of feedback is dependent on the user interaction with the mobile device.

19. The method of claim 15 wherein the user interactions are transmitted to the virtual mobile adaptor from a plurality of mobile devices.

20. The method of claim 15 wherein the feedback stimulus signals the user to do a particular act or to refrain from doing a particular act.
